(19) United States
(12) Patent Application Publication
(10) Pub. No.: US 2024/0053781 A1
(43) Pub. Date: Feb. 15, 2024

(54) LOW-DROPOUT REGULATOR WITH INRUSH CURRENT LIMITING CAPABILITIES

(71) Applicant: ams Sensors Belgium BVBA, Berchem (BE)

(72) Inventors: Carlo FIOCCHI, Belgioioso (IT); Federica RESTA, Segrate (IT); Marco CROCE, Orio Litta (IT)

(21) Appl. No.: 18/255,109

(22) PCT Filed: Nov. 19, 2021
(86) PCT No.: PCT/EP2021/082309

§ 371 Date: May 31, 2023

(30) Foreign Application Priority Data
Dec. 1, 2020 (DE) 10 2020 131 822.7

(51) Int. Cl. G05F 1/573; G05F 1/575

(52) U.S. Cl. CPC G05F 1/573; G05F 1/575

(57) ABSTRACT

A low-dropout regulator with inrush current limiting capabilities may include an output terminal to provide an output signal, a first current branch comprising a pass device connected to the output terminal, and a second current branch comprising a driver transistor and a current generator. The low-dropout regulator may further include an error amplifier to control the driver transistor. The error amplifier may have a first input node to apply a reference signal, and a second input node coupled to the output terminal. The low-dropout regulator may include a current mirror to couple the second current branch to the first current branch. The current mirror is configured to mirror a current in the second current branch to the output current branch.

### CROSS-REFERENCE TO RELATED APPLICATIONS

The present application is a national stage entry according to 35 U.S.C. § 371 of PCT application No.: PCT/EP2021/082309 filed on Nov. 19, 2021; which claims priority to German patent application DE 10 2020 131 822.7, filed on Dec. 1, 2020; all of which are incorporated herein by reference in their entirety and for all purposes.

### TECHNICAL FIELD

The disclosure relates to a low-dropout regulator with inrush current limiting performance. Moreover, the disclosure relates to a communication device comprising an integrated circuit including a low-dropout regulator with inrush current limiting performance.

### BACKGROUND

Low-dropout regulators (LDOs) are used for power management of electronic circuits. Most integrated circuits need internal low-dropout regulators to convert battery voltage that is changing to a stable internal supply, which is needed for blocks inside of the integrated circuits.

A low-dropout regulator comprises a pass device being arranged in an output current path to regulate an output voltage at an output terminal. The pass device is controlled by an error amplifier which generates a control signal to control the pass device in dependence on a comparison of the output voltage with a reference voltage.

The safe switch-on of a low-dropout regulator is a complex matter which requires some aspects to be taken into account. Firstly, it is usually not allowed to generate an overshoot at the output voltage of the low-dropout regulator. An excessive output voltage peak might destroy a load, as in many applications the low-dropout regulator is inserted to supply a circuit with a voltage compatible with its maximum reliability ratings, while starting from a much larger value. Next, it is also of remarkable importance to minimize a large current pulse of an inrush current that could take place when charging a large load capacitance. Across the supply parasitics, this profile might cause large ringing or voltage drops that could interfere with the other circuits that share the same supply.

There is a desire to provide a design of a low-dropout regulator having inrush current limiting capabilities. A further desire is to provide a communication device comprising an integrated circuit including a low-dropout regulator having inrush current limiting performance.

### SUMMARY

An embodiment of a low-dropout regulator with inrush current limiting capabilities is specified in claim 1.

The low-dropout regulator comprises an output terminal to provide an output signal, and a first current branch comprising a pass device being connected to the output terminal. The low-dropout regulator further comprises a second current branch comprising a driver transistor and a current generator. The low-dropout regulator comprises an error amplifier to control the driver transistor. The error amplifier has a first input node to apply a reference signal, and a second input node coupled to the output terminal. The low-dropout regulator further comprises a current mirror to couple the second current branch to the first current branch. The current mirror is configured to mirror a current in the second current branch to the first current branch.

According to the proposed design of the low-dropout regulator, the control over the output current in the first current branch is carried out by the error amplifier by acting on a mirrored replica of the first current branch. In this way the smaller current of the current mirror allows smaller components in comparison to a low-dropout regulator, wherein the error amplifier directly controls the pass device by connecting the output of the error amplifier with a control node/gate node of the pass device/pass transistor. Thus, the proposed approach allows to largely reduce the required area and at the same time to largely reduce the design effort of the low-dropout regulator.

In addition, the current mirror does not undergo the severe swing limitations of the first current branch, further reducing the size of the concerned control node/gate of the pass device/transistor.

The low-dropout regulator comprises a feedback path including a passive circuit that is arranged between the output terminal and the second input node of the error amplifier.

The low-dropout regulator comprises an input supply terminal to provide an input supply voltage, and a reference supply terminal to provide a reference supply voltage. The first current branch is arranged between the input supply terminal and the output terminal. The second current branch is arranged between the input supply terminal and the reference supply terminal. The current generator is arranged between the driver transistor and the reference supply terminal.

The current generator is configured to provide a fixed current in the second current branch. The current generator is arranged in series to the driver transistor so that the current in the first current branch cannot exceed the value set by the current generator and the gain of the current mirror. Hence, the peak current at turn-on of the low-dropout regulator also cannot exceed the value set by the current generator and the gain of the current mirror. The proposed circuit design thus provides an excellent control over the current pulse of the output current at LDO turn-on to put a limit over the peak value.

The current mirror comprises a first transistor being arranged in the first current branch, and a second transistor being arranged in the second current branch. The current mirror may be configured as a PMOS mirror. The first transistor of the current mirror is configured as the pass device. That means that the transistor of the current mirror acts directly as the pass device/pass transistor. The control node/gate node of the pass device/pass transistor is driven by the driver transistor which is controlled by the error amplifier.

According to a possible embodiment of the low-dropout regulator, the driver transistor is configured as a PMOS transistor, particularly as a PMOS source follower transistor. The driver transistor is configured as a PMOS level shift transistor. The control/gate node of the pass device/pass transistor is driven by the error amplifier by means of the PMOS level shift transistor.

According to a possible embodiment of the low-dropout regulator, the current mirror comprises a diode. In particular, the second transistor of the current mirror may be configured as the diode.

According to a possible embodiment of the low-dropout regulator, a current source is arranged in parallel to the second transistor of the current mirror, for example to the diode. The current source provides stability in the case of low load currents and improves the turn-off of the first current branch.

According to a possible embodiment of the low-dropout regulator, the current generator comprises a second current source and a second current mirror. The second current source is connected to the second current mirror.

According to an embodiment of the low-dropout regulator, the second current mirror comprises a third transistor and a fourth transistor. The third transistor is arranged in the second current branch between the driver transistor and the reference supply terminal. The fourth transistor is arranged between the second current source and the reference supply terminal. A control node of the third transistor of the second current mirror is coupled to a control node of the fourth transistor of the second current mirror.

According to a possible embodiment of the low-dropout regulator, the current generator may comprise a controllable switch arranged in parallel to the fourth transistor of the second current mirror.

According to a further embodiment of the low-dropout regulator, the current generator may comprise a filter being configured to filter a control voltage applied to the control node of the third transistor of the second current mirror. The filter may be configured as an RC network.

The filter allows to control the derivative of the inrush current so that the proposed approach of the low-dropout regulator provides an excellent control over the current pulse at LDO turn-on to put a limit over the derivative of the output current. In particular, the use of one filter only is sufficient to reduce the derivative of the output current at LDO turn-on.

An embodiment of a communication device including the low-dropout regulator according to one of the above-described configurations is specified in claim 15.

The communication device comprises an application-specific integrated circuit/ASIC which includes the above-described low-dropout regulator to provide a regulated output voltage. The communication device may be embodied, for example, as a sensor or a battery-powered portable device.

Additional features and advantages of the low-dropout regulator with inrush current limiting capabilities are set forth in the detailed description that follows. It is to be understood that both the foregoing general description and the following detailed description are merely exemplary, and are intended to provide an overview or framework for understanding the nature and character of the claims.

### BRIEF DESCRIPTION OF THE DRAWINGS

The accompanying drawings are included to provide further understanding, and are incorporated in, and constitute a part of, the specification. As such, the disclosure will be more fully understood from the following detailed description, taken in conjunction with the accompanying figures in which:

FIG. 1 shows an embodiment of a low-dropout regulator with inrush current limiting capabilities based on a PMOS level shift solution;

FIG. 2 shows another embodiment of a low-dropout regulator with inrush current limiting capabilities based on an NMOS common source approach;

FIG. 3 illustrates another embodiment of a low-dropout regulator with inrush current limiting capabilities and with an additional control of the derivative of an output current;

and

FIG. 4 shows an embodiment of a communication device including a low-dropout regulator with inrush current limiting capabilities.

### DETAILED DESCRIPTION

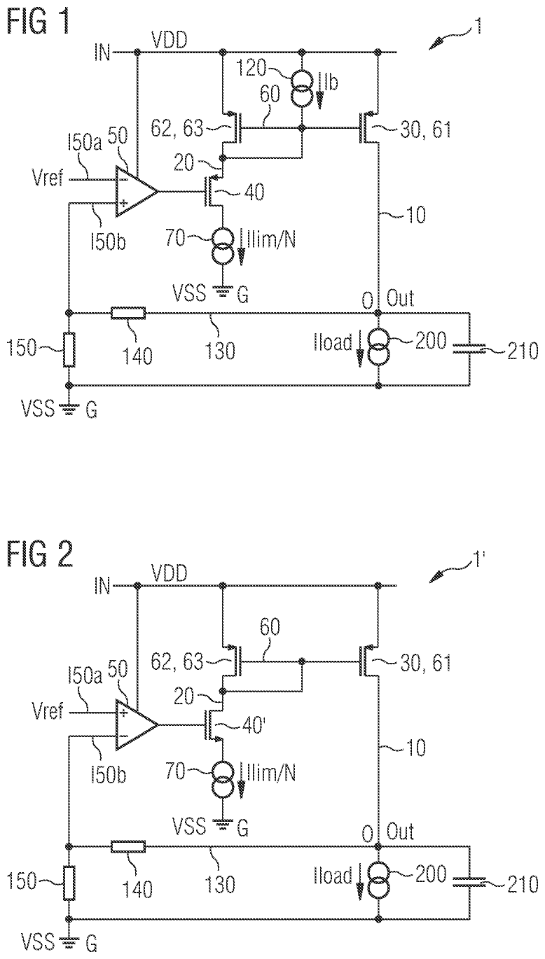

FIG. 1 shows an embodiment of a low-dropout regulator 1 with inrush current limiting capabilities based on a PMOS level shift solution.

The low-dropout regulator 1 comprises an output terminal O to provide an output signal Out, and an first current branch 10 including a pass device 30 that is connected to the output terminal O. The low-dropout regulator 1 further comprises a second current branch 20 comprising a driver transistor 40 and a current generator 70. The low-dropout regulator comprises an error amplifier 50 to control the driver transistor 40. The error amplifier 50 has a first input node 150a to apply a reference signal Vref, and a second input node 150b that is coupled to the output terminal O. The low-dropout regulator 1 further comprises a current mirror 60 which couples the second current branch 20 to the first current branch 10. The current mirror 60 is configured to mirror a current in the second current branch 20 to the first current branch 10.

As illustrated in FIG. 1, the transistor of the current mirror 60 acts directly as the pass device/pass transistor 30. The control node/gate node of the pass device/pass transistor 30 is driven by the error amplifier 50 by means of the driver transistor 40. The transistor 40 may be configured as a PMOS level shift transistor. In particular, the driver transistor 40 is configured as a PMOS source follower transistor.

A low-dropout regulator 1 comprises an input supply terminal IN to provide an input supply voltage Vin, and a reference supply terminal G to provide a reference supply voltage VSS, for example a ground potential. The first current branch 10 is arranged between the input supply terminal IN and the output terminal O. The second current branch 20 is arranged between the input supply terminal IN and the reference supply terminal VSS. The current generator 70 is arranged between the driver transistor 40 and the reference supply terminal G.

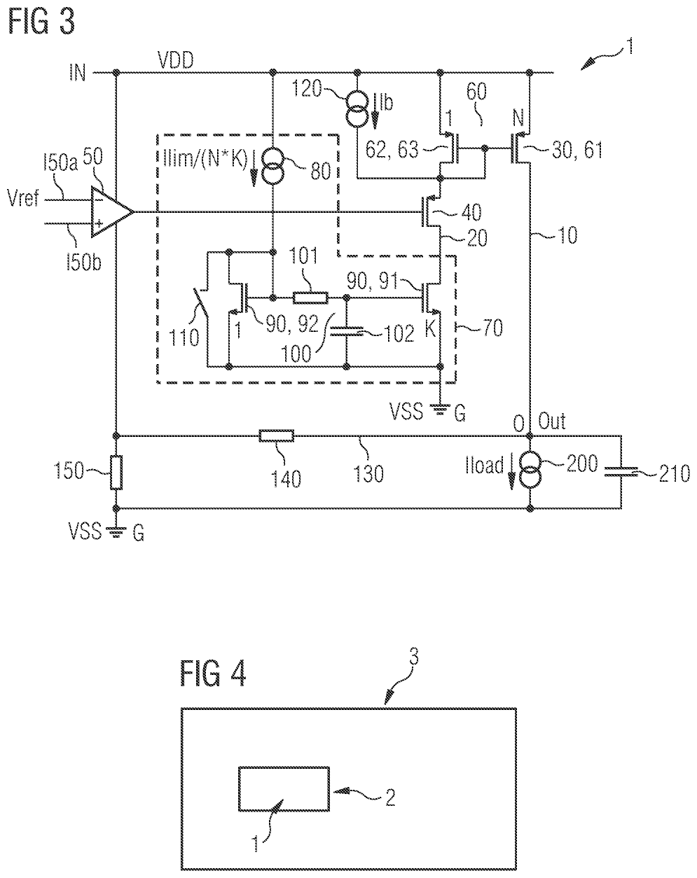

The low-dropout regulator 1 further comprises a feedback path 130 including passive or active circuits 140, 150. The circuits 140, 150 may be configured as a respective resistive element. The feedback path 130 is arranged between the output terminal O and the second input node 150b of the error amplifier 50. In particular, the passive/active circuit 140 is arranged between the output terminal O and the second input node 150b of the error amplifier 50. As further shown in FIG. 3, the second input node 150b of the error amplifier 50 is coupled via the passive circuit 150, for example a resistive element, to the reference supply terminal G to provide the reference supply voltage VSS. The output terminal O of the low-dropout regulator is coupled to a load represented by current source 200 and load capacitor 210.

The current mirror 60 comprises a first transistor 61 being arranged in the first current branch 10, and a second transistor 62 being arranged in the second current branch 20.

The control/gate nodes of the first transistor 61 and the second transistor 62 are connected to each other. As illustrated in FIG. 1, the first transistor 61 is configured as the pass device/pass transistor 30 of the low-dropout regulator. The current mirror 60 is configured as a PMOS mirror.

An internal node of the second current branch 20 located between the current mirror 60, particularly the second transistor 62, and the driver transistor 40 is connected to the connection of the control/gates nodes of the first transistor 61 and the second transistor 62 of the current mirror 60. The internal node of the second current branch is located between the drain node of the second transistor 62 of the current mirror 60 and the source node of the driver transistor 40.

As explained above, the second current branch 20 comprises the current generator 70 that is arranged between the driver transistor 40 and the reference supply terminal G. The current generator 70 is configured to provide a fixed current in the second current branch 20 to limit the current in the second current branch 20 to a level of ILIM/N. The parameter N specifies the mirror relationship of the current mirror 60.

The current generator 70 is connected in series with the driver transistor 40 so that the current in the first current branch/output branch 10 cannot exceed the value set by this current generator 70 and the gain of the current mirror 60. In particular, the current generator 70 coupled to a drain terminal of the driver transistor 40 puts an upper limit to the current in the current mirror 60. In nominal condition the current generator 70 is in triode operation mode and acts as a small resistance between the drain node of the driver transistor 40 and the reference supply terminal G, for example the ground potential. In case, even if much less precise, it can be replaced by a resistor.

As shown in FIG. 1, the current mirror 60 comprises a diode 63. In particular, the second transistor 62 of the current mirror 60 is configured as the (PMOS-)diode 63. The diode 63 is arranged between the input supply terminal IN and the driver transistor 40. In particular, the diode 63 is coupled to a source node of the driver transistor 40. The diode 63 is matched to the pass device/pass transistor 30 by scaling its size of the factor N. This builds up the current mirror 60 with the pass device/pass transistor 30.

According to a possible embodiment of the low-dropout regulator, 1 a current source 120 to provide current Ib may be arranged in parallel to the second transistor 62/diode 63 of the current mirror 60. The current source 120 is arranged between the input supply terminal IN and the connection of the control/gate nodes of the transistors 61 and 62 of the current mirror 60. This configuration of the current source 120 being arranged in parallel to the second transistor 62/diode 63 of the current mirror allows to solve stability concerns, when the load current is very small. In addition it improves the turn-off time for the first current branch.

This arrangement also further speeds up the pole at the control node/gate node of the pass device/pass transistor 30, because the time constant is due to two transconductances in parallel. The maximum current in the current mirror 60 and, consequently, in the first current branch 10 is easily limited by the current generator 70 arranged between the drain node of the level shift transistor 40 and the reference supply terminal G, for example the ground potential.

As soon as the load current of the low-dropout regulator 1 is lower than the maximum one, the driver transistor 40 supplies diode 63 with less current than the one sunk at its drain node. This pulls the drain node of the driver transistor 40 to the reference supply voltage VSS, for example the ground potential, and consequently, the low-dropout regulator 1 operates as usual.

In the case that the control node/gate node of the driver transistor 40 is strongly pulled down, as may happen in start-up conditions, the low impedance due to diode 63 should require a very large current. The consequent current comparison at the drain node of the driver transistor would pull the potential at this node up. The equivalent circuit at the LDO output becomes nothing other than the limiting current generator 70 injecting the fixed current ILIM/N into current mirror 60, hence ensuring perfect control over the maximum allowed current at the output terminal O, while driver transistor 40 acts simply as a turned-on switch.

It has to be noted that this achievement comes without the adoption of any filter. At the same time, no large transistors in the first current branch 10 must be added in series to the pass device/transistor 30 so that the proposed design of the low-dropout regulator has low area consumption.

FIG. 2 shows another approach of a low-dropout regulator 1′ with inrush current limiting capabilities, where the output stage is an NMOS common source stage. Identical elements of both configurations 1 and 1′ of the low-dropout regulator of FIGS. 1 and 2 are referenced with the same reference numbers.

The main difference of the configuration of the low-dropout regulator 1′ shown in FIG. 2 in comparison to the configuration of the low-dropout regulator 1 of FIG. 1 is the configuration of the driver transistor 40′ being configured as an NMOS transistor instead of a PMOS transistor. The upper current mirror 60 (PMOS mirror) is the same as in the PMOS level shift approach shown in FIG. 1. Once the current at the source node of the NMOS driver transistor 40′ is limited by the current generator 70, the control over the inrush current is the same, as explained above for the configuration of the low-dropout regulator 1.

Nevertheless, despite being conceptually similar in terms of the inrush current reduction, the solution shown in FIG. 2 has poorer performances in nominal operation when the load current is high. In fact, at the crossover point, i.e. when the load current is very near the maximum value, a non-negligible drop is necessary at the drain of the limiting current generator 70 to drive the required current. This drop must be tracked by the gate of the driver transistor 40′, and this causes an additional error at the LDO input virtual ground.

This is not the case for the PMOS level shift based solution shown in FIG. 1. Here, the same swing across ILIM/N affects a high impedance node so that only a very minor adjustment at the input of the driver transistor 40 is required to generate it. A negligible error would be referred to the LDO virtual ground and an improved load regulation follows.

On the other hand, a small LDO supply makes the PMOS level shift approach challenging. If the voltage supply is very small, for example 2-2.5 V, a swing limitation at the output of error amplifier 50 makes the NMOS current source approach of FIG. 2 the only viable one. Nevertheless, both proposed embodiments 1 and 1′ of the low-dropout regulator offer a larger operating range for the output voltage vs. the supply one.

FIG. 3 shows a particular embodiment of the current generator 70 for the PMOS level shift approach 1 of the low-dropout regulator of FIG. 1. Identical elements contained in both configurations of the low-dropout regulator of FIG. 1 and FIG. 3 have the same reference signs. Even if only shown in FIG. 3 for the PMOS level shift approach, of course, the same embodiment of the current generator 70 can be adopted in low-dropout regulator 1′.

The low-dropout regulator 1 comprises the first current branch 10 with the pass device/pass transistor 30, and the second current branch 20 with the driver transistor 40 and the current generator 70. The error amplifier 50 is provided to control the driver transistor 40. The driver transistor 40 is configured as a PMOS source follower transistor. The first current branch 10 and the second current branch 20 are coupled by the current mirror 60 comprising first transistor 61 and second transistor 62 being configured as a diode. The current mirror 60 has a mirror relationship of 1:N.

The low-dropout regulator comprises current source 120 being arranged in parallel to the second transistor 62/diode 63 of the current mirror 60. The current source 120 is configured as a bias generator to provide a small fixed bias current Ib. The output voltage Out is fed back by the passive/active circuits 140, 150 being arranged in the feedback path 130 to the second input node 150b of the error amplifier 50.

The embodiment of the current generator 70 is described in more detail below.

The current generator 70 comprises a second current source 80 and a second current mirror 90. The second current source 80 is connected to the second current mirror 90. The current mirror 90 comprises a third transistor 91 and a fourth transistor 92. The third transistor 91 is arranged in the second current branch 20 between the driver transistor 40 and the reference supply terminal G to provide the reference supply voltage VSS, for example the ground potential. The fourth transistor 92 is arranged between the second current source 80 and the reference supply terminal G. The second transistor 92 is configured as a diode, for example an NMOS diode. A control/gate node of the third transistor 91 of the second current mirror 90 is coupled to a control/gate node of the fourth transistor 92 of the second current mirror 90.

As illustrated in FIG. 3, the second current source 80 provides a fixed current ILIM/(NK) which is mirrored by the second current mirror 90 having a mirror relationship of 1:K in the second current branch 20. Diode 63 and current source 120 pull the potential at the source node of the driver transistor 40 up. Diode 63 is matched to the pass device/transistor 30, with a size N times smaller, while current generator 70 is forcing a current into the drain node of driver transistor 40 and transistor 62.

The first transistor 91 of the second current mirror 90 is matched to the second transistor 92 of the second current mirror 90 whose width is K times smaller and biased with current ILIM/K·N provided by the second current source 80.

As a result, the maximum current flowing into the second current branch 20 cannot exceed a value of ILIM/N so that, assuming current Ib provided by current source 120 is negligible, the current mirrored in the first current branch 10 cannot exceed, in any condition, the value ILIM. This implements the desired clipping of the current in the output branch.

As a possible option, the gate-to-source voltage at the first transistor 91 of the second current mirror 90 of the current generator 70 can be shorted at power down and filtered by means of an RC net.

For this purpose, the current generator 70 comprises a filter 100 being configured to filter a control voltage applied to the control/gate node of the third transistor 91 of the second current mirror 90. As shown in FIG. 3, the filter 100 is configured as an RC network comprising resistor 101 and capacitor 102. The resistor 101 is arranged between the control/gate node of the first transistor 91 and the control/gate node of the second transistor 92 of the second current mirror 90. The capacitor 102 is arranged between the control/gate node of the first transistor 91 of the second current mirror 90 and the reference supply terminal G.

As further shown in FIG. 3, the current generator 70 may optionally comprise a controllable switch 110 arranged in parallel to the fourth transistor 92 of the second current mirror 90.

In this way, although the control/gate node of the driver transistor 40 can be very abruptly pulled down to the reference supply voltage VSS, for example the ground potential, the current mirrored in the first current branch 10 cannot suddenly rise, but it would track the exponential profile dictated by the RC product of filter 100. If, on the one hand, this also takes the derivative of the current at the output terminal O under control, on the other hand it has to be noted that the filter 100 is located on a bias section of the current generator 70. This means that, at steady state, the signal path is not affected by its presence and no detrimental effect on the phase margin of the LDO loop would come.

The proposed design for the low-dropout regulator shown in FIGS. 1, 2 and 3 can basically be used in any integrated circuit/ASIC that adopts an LDO.

FIG. 4 shows an exemplified use of the low-dropout regulator, as shown in one of the FIGS. 1, 2 and 3, to provide a regulated output voltage in a communication device 3. The communication device 3 comprises an application-specific integrated circuit/ASIC 2 including the low-dropout regulator 1, 1′ to provide the regulated output voltage Out. The regulated output voltage Out provided by the low-dropout regulator 1, 1′ may be used as a stable power supply for an electronic component of the integrated circuit 2. The communication device 3 can be embodied, for example, as a sensor or a battery-powered portable device.

The embodiments of the low-dropout regulator with inrush current limiting capabilities disclosed herein have been discussed for the purpose of familiarizing the reader with novel aspects of the design of the low-dropout regulator. Although preferred embodiments have been shown and described, many changes, modifications, equivalents and substitutions of the disclosed concepts may be made by one having skill in the art without unnecessarily departing from the scope of the claims.

In particular, the design of the low-dropout regulator with inrush current limiting capabilities is not limited to the disclosed embodiments, and gives examples of many alternatives as possible for the features included in the embodiments discussed. However, it is intended that any modifications, equivalents and substitutions of the disclosed concepts be included within the scope of the claims which are appended hereto.

Features recited in separate dependent claims may be advantageously combined. Moreover, reference signs used in the claims are not limited to be construed as limiting the scope of the claims.

Furthermore, as used herein, the term “comprising” does not exclude other elements. In addition, as used herein, the article “a” is intended to include one or more than one component or element, and is not limited to be construed as meaning only one.

### LIST OF REFERENCE SIGNS

1,1′ low-dropout regulator
2 application-specific integrated circuit
3 communication device
10 first current branch
20 second current branch
30 pass device/transistor
40 driver transistor
50 error amplifier
60 current mirror
61,62 transistor
63 diode
70 current generator
80 current source
90 current mirror
91,92 transistor
100 filter
101 resistor
102 capacitor
110 controllable switch
120 current source
130 feedback path
140,150 passive/active circuit
200 load current source
210 load capacitor
IN input supply terminal
Vin input supply voltage
G reference supply terminal
VSS reference supply voltage
O output terminal
Out output signal
Vref reference voltage
150a,150b input terminals

What is claimed is:

1. A low-dropout regulator with inrush current limiting capabilities, wherein the low-dropout regulator comprises:
an output terminal configured to provide an output signal;
a first current branch comprising a pass device being connected to the output terminal;
a second current branch comprising a driver transistor and a current generator;
an error amplifier configured to control the driver transistor, the error amplifier having a first input node to apply a reference signal and a second input node coupled to the output terminal;
a current mirror to couple the second current branch to the first current branch; and
wherein the current mirror is configured to mirror a current in the second current branch to the output current branch.

2. The low-dropout regulator of claim 1, further comprising:
an input supply terminal configured to provide an input supply voltage;
a reference supply terminal configured to provide a reference supply voltage;
wherein the first current branch is arranged between the input supply terminal and the output terminal;
wherein the second current branch is arranged between the input supply terminal and the reference supply terminal; and
wherein the current generator is arranged between the driver transistor and the reference supply terminal.

3. The low-dropout regulator of claim 1,
wherein the current mirror comprises a first transistor arranged in the first current branch and a second transistor arranged in the second current branch, and
wherein the first transistor is configured as the pass device.

4. The low-dropout regulator of claim 3,
wherein the current mirror comprises a diode, and
wherein the second transistor of the current mirror is configured as the diode.

5. The low-dropout regulator of claim 3, further comprising a current source arranged in parallel to the second transistor of the current mirror.

6. The low-dropout regulator of claim 1, wherein the driver transistor is configured as a PMOS source follower transistor.

7. The low-dropout regulator of claim 1, wherein the driver transistor is configured as an NMOS transistor.

8. The low-dropout regulator of claim 1,
wherein the current generator comprises a second current source and a second current mirror, and
wherein the second current source is connected to the second current mirror.

9. The low-dropout regulator of claim 8,
wherein the second current mirror comprises a third transistor and a fourth transistor,
wherein the third transistor is arranged in the second current branch between the driver transistor and the reference supply terminal, and
wherein the fourth transistor is arranged between the second current source and the reference supply terminal.

10. The low-dropout regulator of claim 9,
wherein a control node of the third transistor of the second current mirror is coupled to a control node of the fourth transistor of the second current mirror.

11. The low-dropout regulator of claim 10,
wherein the current generator comprises a filter being configured to filter a control voltage applied to the control node of the third transistor of the second current mirror.

12. The low-dropout regulator of claim 11,
wherein the filter is configured as an RC network.

13. The low-dropout regulator of claim 9, wherein the current generator comprises a controllable switch arranged in parallel to the fourth transistor of the second current mirror.

14. The low-dropout regulator of claim 9, further comprising:
a feedback path including a passive or active circuit arranged between the output terminal and the second input node of the error amplifier.

15. A communication device comprising:
an application-specific integrated circuit comprising a low-dropout regulator of claim 1 to provide a regulated output voltage; and
wherein the communication device is embodied as a sensor or a battery-powered portable device.
